(19) United States
(12) Patent Application Publication
(10) Pub. No.: US 2025/0024786 A1
(43) Pub. Date: Jan. 23, 2025

(54) Round Hay Bale Pickup and Releasing Apparatus

(71) Applicant: Paul Andrew Derstine, Sheldon, WI (US)

(72) Inventor: Paul Andrew Derstine, Sheldon, WI (US)

(21) Appl. No.: 18/641,124

(22) Filed: Apr. 19, 2024

Related U.S. Application Data
(60) Provisional application No. 63/514,059, filed on Jul. 17, 2023.

(51) Int. Cl. A01D 87/12

(52) U.S. Cl. CPC A01D 87/127

(57) ABSTRACT

A round hay bale pickup and releasing apparatus includes a frame assembly, a loading-arm mechanism, a bale-pushing mechanism, a wheel assembly, and a tilting mechanism. The frame assembly is configured with a first frame-shaft and a second frame-shaft and provides sufficient length to load and transport round hay bales. The loading-arm mechanism is operatively coupled to the first frame-shaft and the second frame-shaft to pick up and loads the round hay bales onto the frame assembly. The bale-pushing mechanism is operatively coupled to the first frame-shaft and the second frame-shaft so that each of the loaded hay bale can be pushed towards the back end of the frame assembly. The wheel assembly is operatively coupled to the first frame-shaft and the second frame-shaft through the tilting mechanism, as the tilting mechanism angularly lifts up the first frame-shaft above the second frame-shaft to dump the loaded hay bales.

The current application claims a priority to the U.S. Provisional Patent application Ser. No. 63/514,059 filed on Jul. 17, 2023.

### FIELD OF THE INVENTION

The present invention relates generally to a device that quickly picks up and releases round hay bales in the field. More specifically, the present invention picks up and loads several round hay bales and transports the round hay bales into the desired location without damaging the field. The present invention is then able to quickly unload the round hay bales without damaging the round hay bales.

### BACKGROUND OF THE INVENTION

Picking up bales of hay is an essential task in farming that involves the collection and transportation of bundled dried grass or straw, known as hay bales. This process is crucial for storing and feeding livestock, as well as managing agricultural land. Many of the existing round bale moves are clumsy and crude thus damaging the hay bales and the souring farmland. These machines and methods can sometimes damage the bales of hay when being lifted or unloaded. Further, these machines and methods can damage the farmland when picking up a bale.

An objective of the present invention is to provide users with an apparatus that quickly loads, transports, and unloads bales of hay, to help expedite the process without damaging the bales of hay or surrounding farmland. The present invention intends to provide users with a system that utilizes a double pivot that easily secures and loads a bale of hay while an attached external vehicle of the present invention continues to move. As a result, the present invention is capable of continuously picking up directionally positioned hay bales while travelling in the same direction of travel as the external vehicle. In order to accomplish that, a preferred embodiment of the present invention comprises a tilting assembly and a pickup arm assembly. More specifically, the pickup arm assembly allows for a quick pickup of a bale of hay and allows the tilting assembly to quickly unload the transported hay bales. Thus, the present invention is a system that conveniently picks up, loads, and unloads bales of hay within the field while reducing or eliminating any damage to the bales of hay or surrounding field.

### SUMMARY OF THE INVENTION

The present invention is an apparatus that loads and unloads bales of hay to help with transporting bales of hay around a field. The present invention seeks to provide users with a device that can efficiently load bales of hay without damaging the bale or surrounding field. In order to accomplish this, the present invention comprises a pickup arm assembly that lifts and loads bales of hay onto a frame assembly of the present invention. Furthermore, the present invention comprises a tilting assembly that quickly unloads bales of hay without damaging surrounding farmland.

### BRIEF DESCRIPTION OF THE DRAWINGS

FIG. 1 is a top perspective view of the present invention.

FIG. 2 is a bottom perspective view of the present invention.

FIG. 3 is a top view of the present invention.

FIG. 4 is a detailed view taken about circle 4 in FIG. 3 showing the loading-arm mechanism.

FIG. 5 is a detailed view of the loading-arm mechanism of the present invention.

FIG. 6 is a detailed view taken about circle 6 in FIG. 3 showing the wheel assembly and the tilting mechanism.

FIG. 7 is a top view showing the configuration of the first bale gripper and the second bale gripper before reaching the hay bale.

FIG. 8 is a top view showing the configuration of the first bale gripper and the second bale gripper after reaching the hay bale, wherein the first bale gripper initiates the rolling process of the hay bale.

FIG. 9 is a top view showing the configuration of the first bale gripper and the second bale gripper after reaching the hay bale, wherein the rotation of the second bale gripper secures the hay bale into the first bale gripper.

FIG. 10 is a top view showing the configuration of the first bale gripper and the second bale gripper after reaching the hay bale, wherein the first bale gripper and the second bale gripper rotate the hay bale toward the frame assembly.

FIG. 11 is a front view of the present invention after reaching the hay bale, wherein the first bale gripper and the second bale gripper rotate the hay bale toward the frame assembly and initiating the rotation of the lift arm.

FIG. 12 is a front view of the present invention after reaching the hay bale, wherein the lift arm rotates toward the frame assembly to load the hay bale onto the frame assembly.

### DETAILED DESCRIPTION OF THE INVENTION

All illustrations of the drawings are for the purpose of describing selected versions of the present invention and are not intended to limit the scope of the present invention.

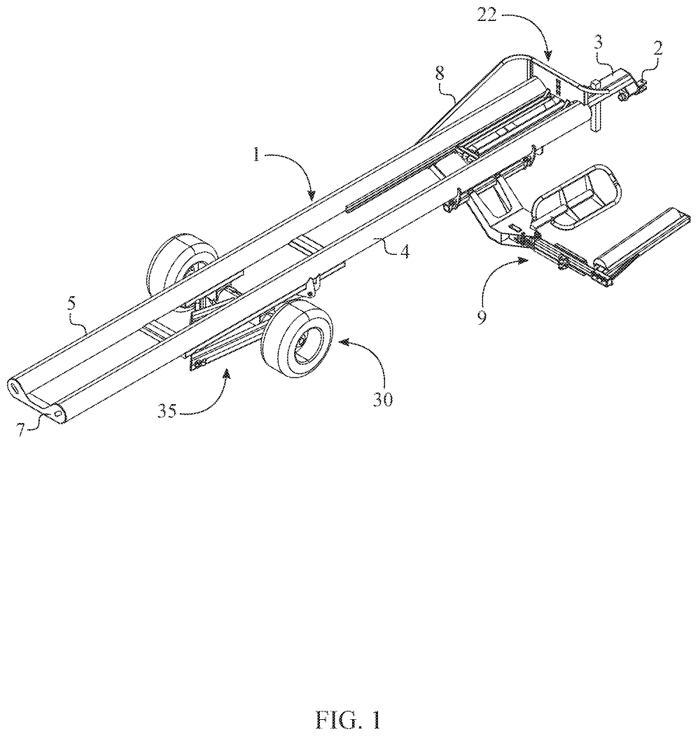

The present invention is an apparatus for picking up, transporting, and unloading round bales in the field. More specifically, the present invention is able to pick up and transport round hay bales without damaging the bales or the surrounding field. Once the round hay bales reach the desired location, the present invention is able to unload the round hay bales without damaging the round hay bales and ensuring that the round hay bales do not land on their ends. To accomplish aforementioned functionality, the present invention comprises a frame assembly 1, a loading-arm mechanism 9, a bale-pushing mechanism 22, a wheel assembly 30, and a tilting mechanism 35 as shown in FIG. 1.

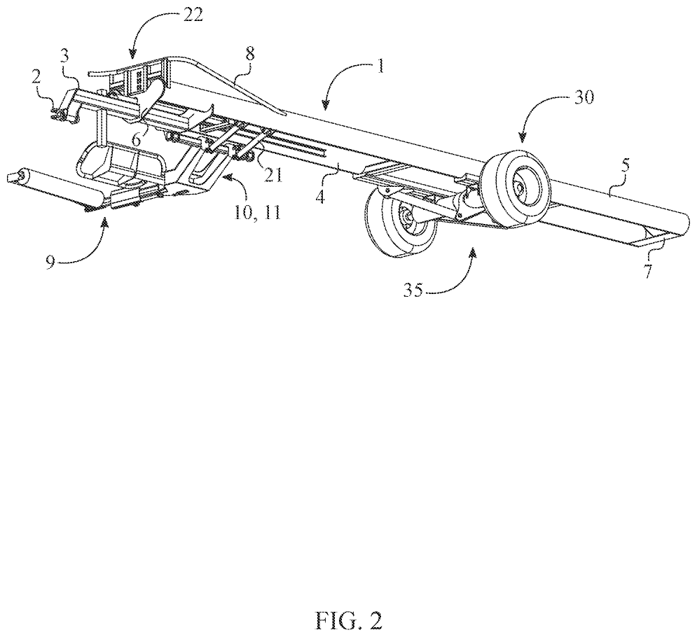

In reference to the general configuration of the present invention, as shown in FIG. 1 and FIG. 2, the frame assembly 1 that functions as a platform to transport the hay bales comprises a first frame-shaft 4, a second frame-shaft 5, a front plate 6, and a rear plate 7. More specifically, the first frame-shaft 4 and the second frame-shaft 5 are positioned parallel to each other and connected to each other by the front plate 6 and the rear plate 7. The front plate 6 and the rear plate 7 are oppositely positioned of each other about the first frame-shaft 4 and the second frame-shaft 5 as the front plate 6 and the rear plate 7 function as the end plates of the frame assembly 1. The loading-arm mechanism 9 is positioned adjacent to the front plate 6 and oriented away from the first frame-shaft 4. The loading-arm mechanism 9 is operatively coupled to the first frame-shaft 4 and the second frame-shaft 5 thus enabling the loading-arm mechanism 9 to pick up and load the hay bales onto the first frame-shaft 4 and the second frame-shaft 5. The bale-pushing mechanism 22 is positioned adjacent to the front plate 6 and operatively coupled to the first frame-shaft 4 and the second frame-shaft 5. Once a hay bale is loaded onto the first frame-shaft 4 and the second frame-shaft 5, the bale-pushing mechanism 22 pushes the hay bale from the front plate 6 to the rear plate 7 so that a subsequent hay bale can be loaded onto the first frame-shaft 4 and the second frame-shaft 5. The wheel assembly 30 is positioned in between the front plate 6 and the rear plate 7 and mounted to the frame assembly 1 so that the present invention can be pulled by an external vehicle such as a tractor or a baler. The tilting mechanism 35 is positioned adjacent to wheel assembly 30 and functions as the unloading mechanism for the hay bales. In other words, the wheel assembly 30 is connected to the first frame-shaft 4 and the second frame-shaft 5 through the tilting mechanism 35 so that the tilting mechanism 35 can angularly lift up the first frame-shaft 4 above the second frame-shaft 5 to dump the hay bales.

The first frame-shaft 4 and the second frame-shaft 5 extend along the length of the present invention away from the external vehicle. As shown in FIG. 1 and FIG. 2, the first frame-shaft 4 and the second frame-shaft 5 formed into a cylindrical shape as the parallel positioning of the first frame-shaft 4 and the second frame-shaft 5 allows the hay bales to be properly secured within and easily push back along the first frame-shaft 4 and the second frame-shaft 5. The front plate 6 and the rear plate 7 function as structural members so that the first frame-shaft 4 and the second frame-shaft 5 can maintain the parallel positioning.

In reference to FIG. 1 and FIG. 2, the frame assembly 1 may further comprise a swivel attachment 2, a tongue 3, and a fence 8. The tongue 3 is centrally positioned in between the first frame-shaft 4 and the second frame-shaft 5 and connected to the front plate 6. The tongue 3 is outwardly oriented from the front plate 6 as the swivel attachment 2 is rotatably connected to the tongue 3. More specifically, the tongue 3 provides sufficient clearance so that the external vehicle can safely turn without hitting the first frame-shaft 4 and the second frame-shaft 5. The swivel attachment 2 is located into the front side of tongue 3 so that the present invention can be attached to the external vehicle. The swivel attachment 2 allows for the present invention to rotate while being pulled or pushed by the external vehicle. The swivel attachment 2 is designed to receive and connect to any standard trailer hitch where a pin is placed through a U-shaped bracket section of the swivel attachment 2 to secure the frame assembly 1 to the external vehicle. The fence 8 is externally connected to the second frame-shaft 5 and oppositely positioned to the loading-arm mechanism 9. The fence 8 is able to stop the rotational movement of the hay bale after the hay bale is loaded onto the first frame-shaft 4 and the second frame-shaft 5 thus preventing unintentional rollout of the hay bale during the loading process.

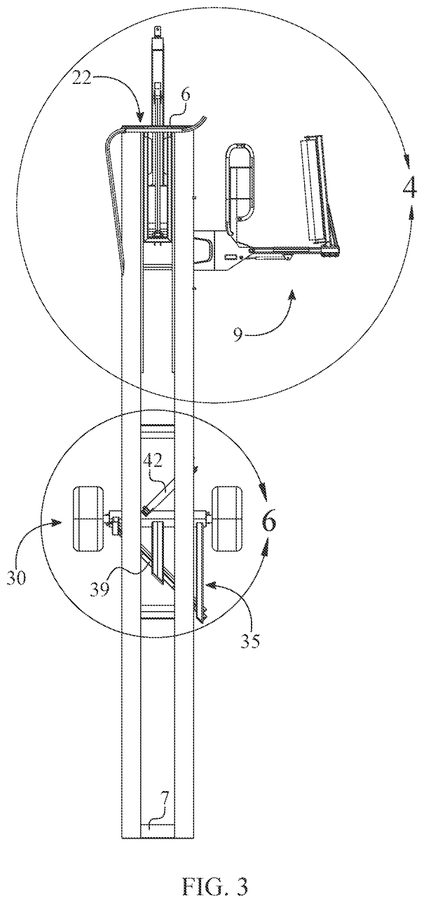

The loading-arm mechanism 9 is outwardly oriented from the first frame-shaft 4 so that the hay bale can be secured, lifted, and placed onto the first frame-shaft 4 and the second frame-shaft 5. The loading-arm mechanism 9 is designed to support the weight of the hay bale and balance the frame assembly 1 during the loading process. In reference to FIGS. 3-5, the loading-arm mechanism 9 may comprise a lift arm 10, a first bale gripper 13, a second bale gripper 18, a first linear actuator 19, a second linear actuator 20, and at least one third linear actuator 21. A proximal end 11 of the lift arm 10 is rotatably connected to the first frame-shaft 4 and functions as the structural member that lifts up the hay bale. The at least one third linear actuator 21 is terminally mounted to the second frame-shaft 5 and the proximal end 11 of the lift arm 10 so that the lifting arm can be operated. The first bale gripper 13 is pivotably connected to a distal end 12 of the lift arm 10 and operated via the first linear actuator 19 that is terminally mounted to the first bale gripper 13 and the distal end 12 of the lift arm 10. The second bale gripper 18 is pivotally connected to the distal end 12 of the lift arm 10 and operated via the second linear actuator 20 that is terminally mounted to the first bale gripper 13 and the second bale gripper 18. In other words, the first bale gripper 13 and the second bale gripper 18 are connected to a rotating pin of the lift arm 10 that functions as a double pivot.

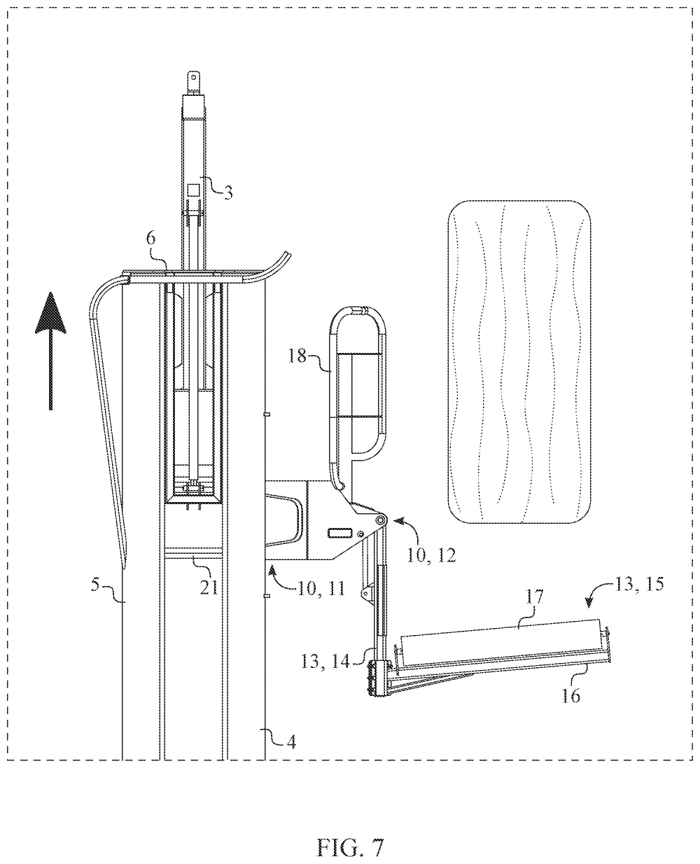

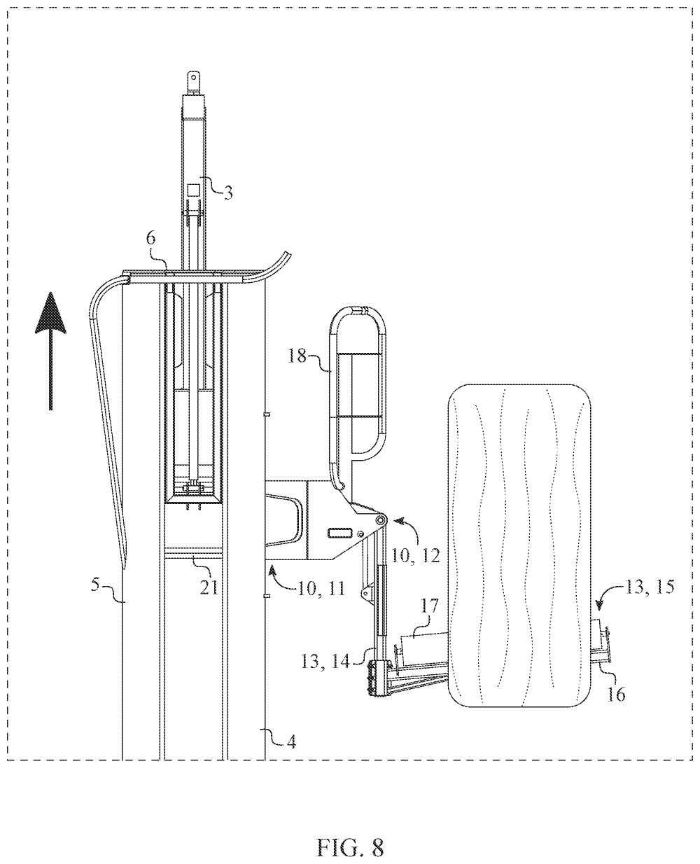

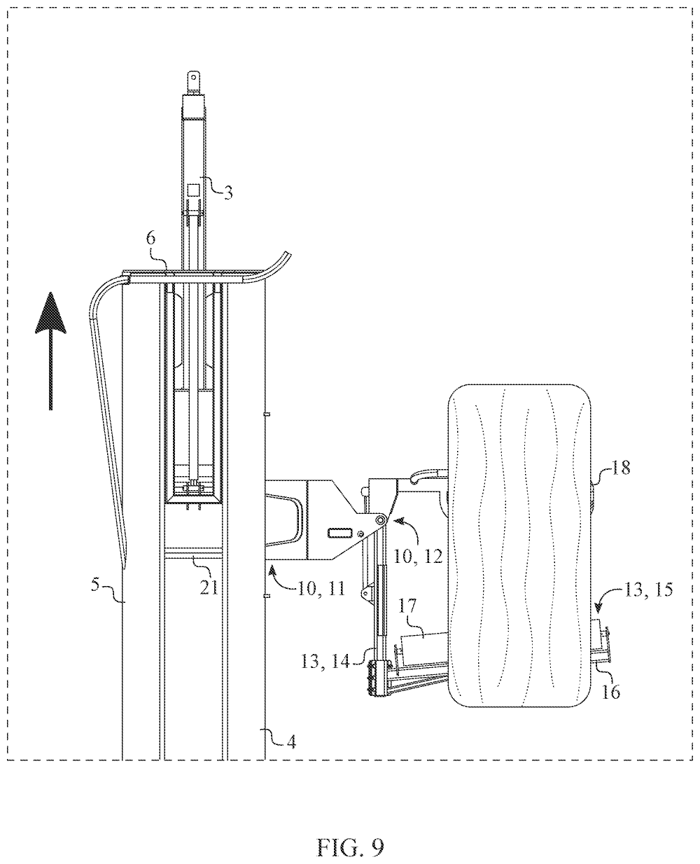

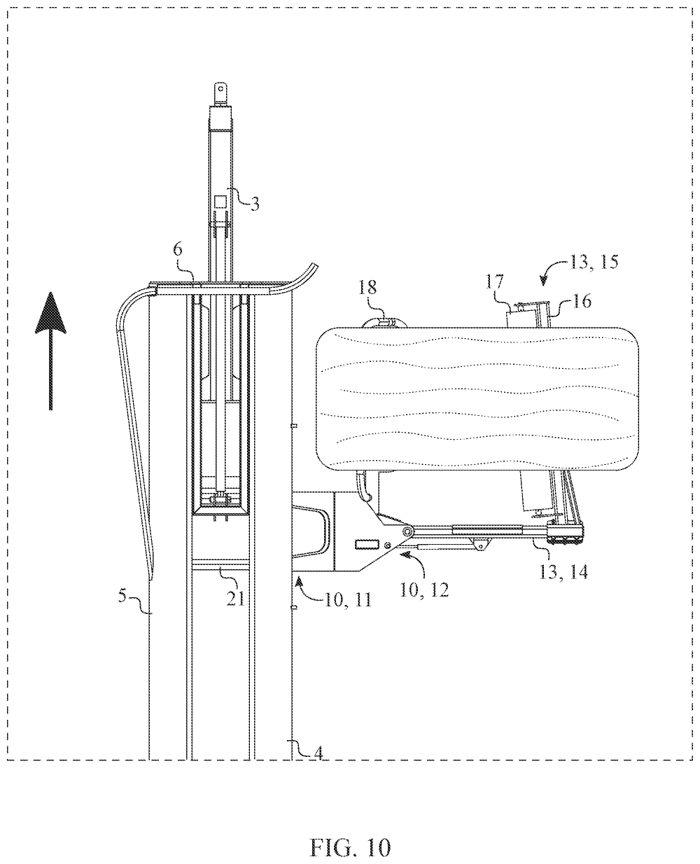

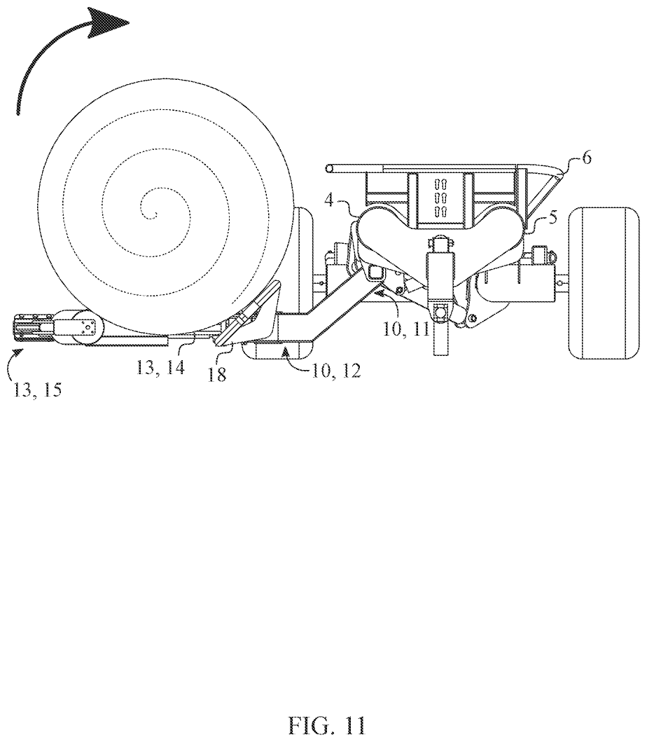

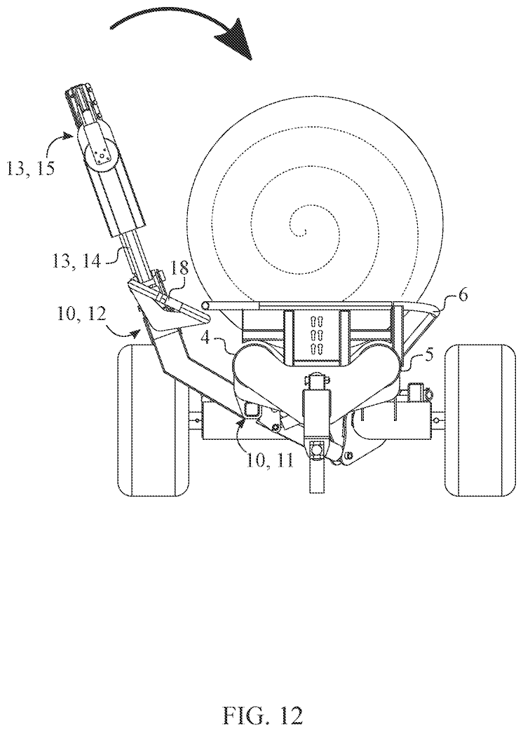

Before loading-arm mechanism 9 is operational, the hay bales are created by the baler (machine that makes the round hay bales) and directionally positioned along the field. In reference to FIGS. 7-12, when the loading-arm mechanism 9 is operational, the first bale gripper 13 makes the initial contact with the back end of the hay bale and rolls the hay bale forward. Then, the second bale gripper 18 rotates towards the front end of the hay bale via the operation of the second linear actuator 20 so that the second bale gripper 18 can secure the hay bale against the first bale gripper 13. Then, both the first bale gripper 13 and the second bale gripper 18 are rotated toward the first frame-shaft 4 via the operation of the first linear actuator 19 so that that the bale-end of the hay bale can be positioned parallel to the front plate 6. Once the bale-end is positioned parallel to the front plate 6, the lift arm 10 picks up the hay bale and rolls the hay bale onto the first frame-shaft 4 and the second frame-shaft 5. Due to the positioning of the fence 8, the hay bale does not roll out from the second frame-shaft 5 and stays within the frame assembly 1.

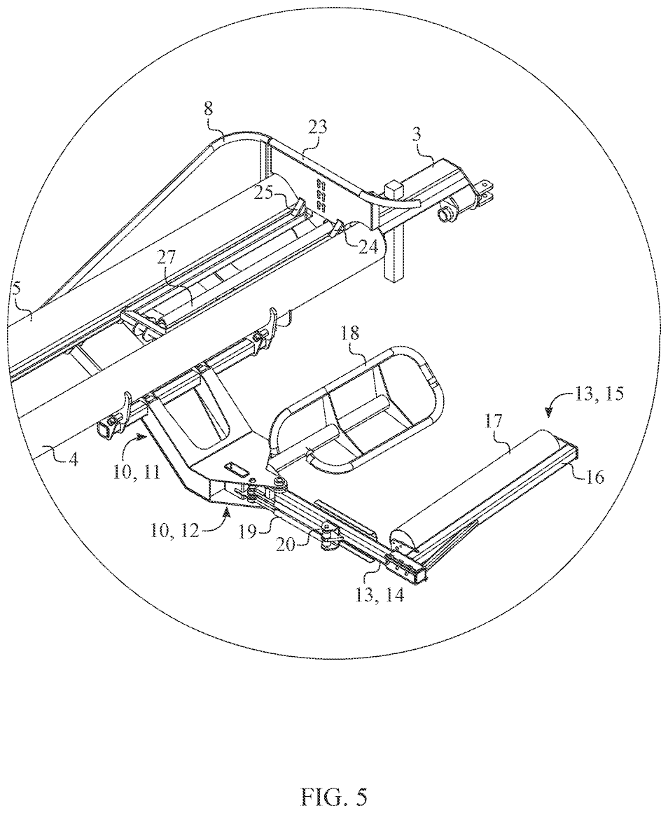

In reference to FIG. 5, the second bale gripper 18 is configured with curved extending poles or webbing to create a curved shape that allows for a scooping function of the hay bale. The second bale gripper 18 is designed to provide a force along the bottom and the front end of the hay bale to ensure it is properly secured.

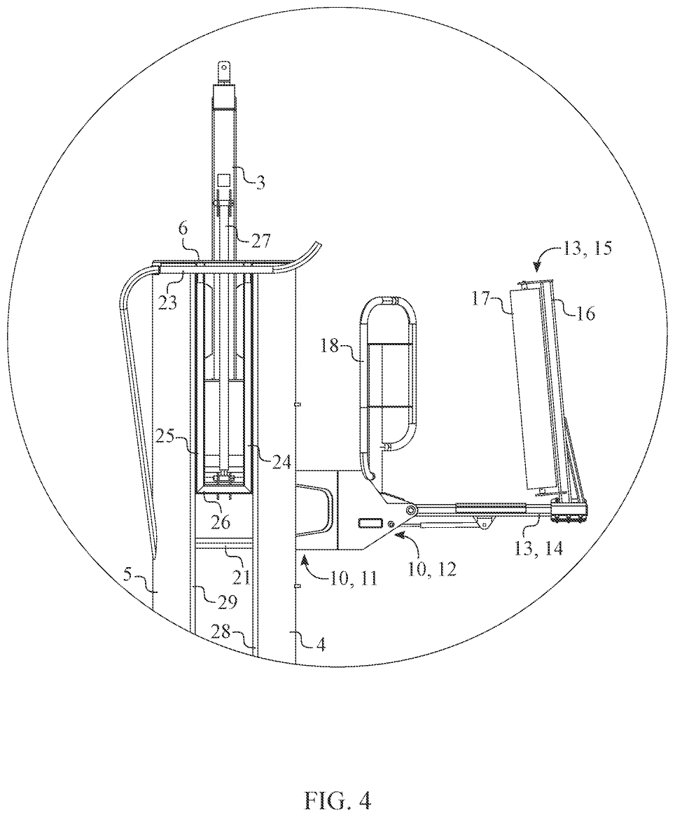

In reference to FIG. 4 and FIG. 5, the first bale gripper 13 may comprise an extension arm 14 and a rolling arm 15 so that the first bale gripper 13 can be configured onto an L-shaped structure. More specifically, the extension arm 14 is terminally and adjustably mounted to the distal end 12 of the lift arm 10. The rolling arm 15 is positioned offset to the distal end 12 of the lift arm 10 and terminally connected to the extension arm 14 at an acute angle. The attachment between the rolling arm 15 and the extension arm 14 allows the rolling arm 15 to adjustably extend or shorten in length to accommodate various sized bales of hay with respect to the extension arm 14. When the present invention is operational, the extension arm 14 is positioned parallel to the first frame-shaft 4 as the rolling arm 15 is positioned perpendicular to the first frame-shaft 4. Furthermore, the second bale gripper 18 is also positioned parallel to the first frame-shaft 4 thus allowing the hay bale to be aligned with the rolling arm 15. The rolling arm 15 may comprise an elongated shaft 16 and a bale roller 17 so that the rolling arm 15 can position slightly above the field and initiate the rolling process of the hay bale once in contact. The bale roller 17 is rotatably mounted along the elongated shaft 16 in such a way that the elongated shaft 16 is terminally connected to the extension arm 14. More specifically, the bale roller 17 is a cylindrical pole that rotates around the central axis of the bale roller 17 to gently roll the hay bale forward. The bale roller 17 is positioned in between the elongated shaft 16 and the extension arm 14 thus allowing the bale roller 17 to contact the back end of the hay bale. When the rolling arm 15 rolls forward the hay bale, the second bale gripper 18 rotates towards the front end of the hay bale. The second bale gripper 18 is then able to secure the hay bale against the rolling arm 15 so that that the bale-end of the hay bale can be positioned parallel to the front plate 6. In order to allow the double pivot functionality of the rotating pin, the first linear actuator 19 is terminally mounted to the extension arm 14 and the distal end 12 of the lift arm 10, and the second linear actuator 20 is terminally mounted to the extension arm 14 and the second bale gripper 18. Furthermore, the rolling arm 15 allows for hay bale to be rolled and picked up while the present invention is moving and, on the go, instead of requiring the present invention to stop in order to pick up the hay bale. Due to the perpendicular positioning of the bale roller 17 to the extension arm 14, the rolling arm 15 allows the hay bales to be picked up while travelling in the same direction of travel as the external vehicle.

The first linear actuator 19, the second linear actuator 20, and the third linear actuator 21 are preferably actuated with hydraulic fluid so that sufficient power can be generated within. It is understood that the first linear actuator 19, the second linear actuator 20, and the third linear actuator 21 are in fluid communication with a hydraulic tank of the external vehicle or a separate hydraulic tank so that the corresponding actuator can be powered. Furthermore, the pressure regulators or sensors can be integrated into the first linear actuator 19, the second linear actuator 20, and the third linear actuator 21 so that the sequential operation order can be determined within the present invention. For example, once pressure is detected by the first bale gripper 13, the second linear actuator 20 closes the second bale gripper 18. Due to the pressure detection of the second bale gripper 18, the first linear actuator 19 then rotates the hay bale to initiate the loading process. Due to the activation of the first linear actuator 19 and the second linear actuator 20, the third linear actuator 21 is then activated thus loading the hay bale onto the frame assembly 1.

The bale-pushing mechanism 22 that pushes the loaded hay bale towards the rear plate 7 may comprise a push plate 23, a first support 24, a second support 25, a cross beam 26, a fourth linear actuator 27, a first track 28, and a second track 29 as shown in FIG. 4 and FIG. 5. The first track 28 is connected along the first frame-shaft 4 and linearly extended from the front plate 6. The second track 29 is connected along the second frame-shaft 5 and linearly extended from the front plate 6. The first support 24 is positioned parallel to the second support 25 so that the push plate 23 is able to slide back and forth along the first track 28 and the second track 29. More specifically, the push plate 23 is a flat structural body that is perpendicularly connected to the first support 24 and the second support 25. The cross beam 26 is connected to the first support 24 and the second support 25 and opposite of the push plate 23 so that the first support 24 and the second support 25 can maintain their parallel positioning. The push plate 23 is positioned parallel to the front plate 6 as the first support 24 is slidably engaged to the first track 28, and the second support 25 is slidably engaged to the second track 29. The fourth linear actuator 27 is terminally mounted to the cross beam 26 and the tongue 3 of the frame assembly 1 so that the fourth linear actuator 27 is able to actuate the back-and-forth movement of the push plate 23. For example, when the hay bale is loaded to the frame assembly 1, the fourth linear actuator 27 is activated so that the cross beam 26, the first support 24, the second support 25, and the push plate 23 can be simultaneously moved toward the rear plate 7. Resultantly, the push plate 23 is then able to drive back the loaded hay bale thus allowing the subsequent hay bale to be loaded onto the first frame-shaft 4 and the second frame-shaft 5. The fourth linear actuator 27 is preferably actuated with hydraulic fluid so that sufficient power can be generated within to push back the loaded hay bale. It is understood that the fourth linear actuator 27 is in fluid communication with a hydraulic tank of the external vehicle or a separate hydraulic tank so that the fourth linear actuator 27 can be powered.

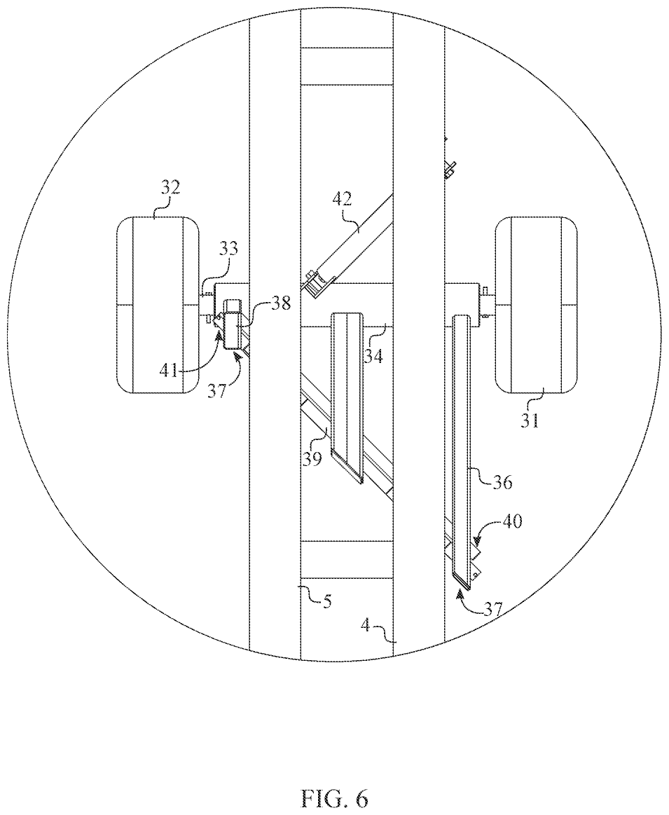

The wheel assembly 30 ensures that the present invention smoothly follows the path of the external vehicle and elevates the frame assembly 1 off the ground. In reference to FIG. 6, the wheel assembly 30 may comprise a first wheel 31, a second wheel 32, an axle shaft 33, and an axle housing 34. The axle shaft 33 is rotatably mounted within the axle housing 34 as the tilting mechanism 35 connects the axle housing 34 to the first frame-shaft 4 and the second frame-shaft 5. The first wheel 31 and the second wheel 32 are positioned opposite of each other about the axle shaft 33 so that the frame assembly 1 can be balanced within the wheel assembly 30. More specifically, the first wheel 31 is mounted to the axle shaft 33 and externally positioned to the first frame-shaft 4. The second wheel 32 is mounted to the axle shaft 33 and externally positioned to the second frame-shaft 5.

The tilting mechanism 35 enables the dumping of the loaded hay bale. In reference to FIG. 3 and FIG. 6, the tilting mechanism 35 may comprise a first mount 36, a second mount 38, a connector shaft 39, and a fifth linear actuator 42. The first mount 36 is terminally connected to the axle housing 34 and positioned in between the first frame-shaft 4 and the first wheel 31. The second mount 38 is terminally connected to the axle housing 34 and positioned in between the second frame-shaft 5 and the second wheel 32. Preferably, the length of the length of the first mount 36 is greater than the length of the second mount 38. The connector shaft 39 is terminally connected to a free end 37 of the first mount 36 and the free end 37 of the second mount 38 as the connector shaft 39 is angularly oriented toward the rear plate 7. Preferably, the connector shaft 39 and the axle housing 34 are positioned at a 45-degree angle. The connector shaft 39 is connected to the first frame-shaft 4 and the second frame-shaft 5 thus mounting the wheel assembly 30 to the frame assembly 1. More specifically, a first end 40 of the connector shaft 39 is positioned offset to the axle housing 34 and adjacent to the first frame-shaft 4 as the connector shaft 39 is adjacently connected to the first frame-shaft 4. A second end 41 of the connector shaft 39 is positioned adjacent to the axle housing 34 and adjacent to the second frame-shaft 5 as the connector shaft 39 is adjacently connected to the second frame-shaft 5. The fifth linear actuator 42 is terminally mounted to the first frame-shaft 4 and the axle housing 34 and angularly oriented toward the front plate 6. Preferably, the fifth linear actuator 42 and the axle housing 34 are positioned at a 45-degree angle. Due to the length difference of the first mount 36 and the second mount 38, the angular positioning of the connector shaft 39, and the angular positioning of the fifth linear actuator 42, the present invention is able to dump the loaded hay bale over the second frame-shaft 5 as the fifth linear actuator 42 angularly tilts the frame assembly 1.

When the fifth linear actuator 42 is activated, the fifth linear actuator 42 applies upward pressure to the first frame-shaft 4. Then, the fifth linear actuator 42 is able to lift up the first frame-shaft 4 above the second frame-shaft 5 while applying downward pressure to the first wheel 31 and the second wheel 32. The first mount 36 and the second mount 38 are designed to be extended upward and diagonally as the first frame-shaft 4 angularly rotates above the second frame-shaft 5. The upward movement of the first frame-shaft 4 accomplishes the tilting motion so that the loaded hay bales can be dumped over the second frame-shaft 5. Simultaneously, the actuation of the fifth linear actuator 42 pushes the first wheel 31 toward the rear plate 7 thus converting the perpendicular positioning of the wheel assembly 30 and frame assembly 1 into an angular positioning of the wheel assembly 30 and the frame assembly 1. As a result, when the present invention is pulled forward, the frame assembly 1 diagonally moves forward and away from the dumping of the hay bales. It should be further noted that the tilting mechanism 35 can be configured in many various shapes, sizes, and various configurations while still staying within the scope of the functionality. The swivel attachment 2 also facilitates the rotational movement of the frame assembly 1 so that the external vehicle does not tip over during the operation of the fifth linear actuator 42.

Although the invention has been explained in relation to its preferred embodiment, it is to be understood that many other possible modifications and variations can be made without departing from the spirit and scope of the invention as hereinafter claimed.

What is claimed is:

1. A round hay bale pickup and releasing apparatus comprising:
a frame assembly;
a loading-arm mechanism;
a bale-pushing mechanism:
a wheel assembly;
the frame assembly comprising a first frame-shaft, a second frame-shaft, a front plate, and a rear plate;
the first frame-shaft and the second frame-shaft being positioned parallel to each other;
the first frame-shaft and the second frame-shaft being connected to each other by the front plate and the rear plate;
the front plate and the rear plate being oppositely positioned of each other about the first frame-shaft and the second frame-shaft;
the loading-arm mechanism being positioned adjacent to the front plate;
the loading arm being oriented away from the first frame-shaft;
the loading-arm mechanism being operatively coupled to the first frame-shaft and the second frame-shaft, wherein the loading-arm mechanism picks up and loads a round hay bale onto the first frame-shaft and the second frame-shaft;
the bale-pushing mechanism being positioned adjacent to the front plate;
the bale-pushing mechanism being operatively coupled to the first frame-shaft and the second frame-shaft, wherein the bale-pushing mechanism pushes the round hay bale from the front plate to the rear plate;
the wheel assembly being positioned in between the front plate and the rear plate; and
the wheel assembly being mounted to the frame assembly.

2. The round hay bale pickup and releasing apparatus as claimed in claim 1 comprising:
the frame assembly further comprising a swivel attachment, a tongue, and a fence;
the tongue being centrally positioned in between the first frame-shaft and the second frame-shaft;
the tongue being connected to the front plate;
the tongue being outwardly oriented from the front plate;
the swivel attachment being rotatably connected to the tongue;
the fence being externally connected to the second frame-shaft; and
the fence being oppositely positioned to the loading-arm mechanism.

3. The round hay bale pickup and releasing apparatus as claimed in claim 1 comprising:
the loading-arm mechanism comprising a lift arm, a first bale gripper, a second bale gripper, a first linear actuator, a second linear actuator, and at least one third linear actuator;
a proximal end of the lift arm being rotatably connected to the first frame-shaft;
the at least one third linear actuator being terminally mounted to the second frame-shaft and the proximal end of the lift arm;
the first bale gripper being pivotably connected a distal end of the lift arm;
the first linear actuator being terminally mounted to the first bale gripper and the distal end of the lift arm;
the second bale gripper being pivotally connected the distal end of the lift arm; and
the second linear actuator being terminally mounted to the first bale gripper and the second bale gripper.

4. The round hay bale pickup and releasing apparatus as claimed in claim 3 comprising:
the first bale gripper comprising an extension arm and a rolling arm;
the extension arm being terminally mounted to the distal end of the lift arm;
the rolling arm being positioned offset to the distal end of the lift arm;
the rolling arm being terminally connected to the extension arm at an acute angle;
the first linear actuator being terminally mounted to the extension arm and the distal end of the lift arm; and
the second linear actuator being terminally mounted to the extension arm and the second bale gripper.

5. The round hay bale pickup and releasing apparatus as claimed in claim 4 comprising:
the rolling arm comprising an elongated shaft and a bale roller;
the bale roller being rotatably mounted along the elongated shaft;
the elongated shaft being terminally connected to the extension arm; and
the bale roller being positioned in between the elongated shaft and the extension arm.

6. The round hay bale pickup and releasing apparatus as claimed in claim 1 comprising:
the bale-pushing mechanism comprising a push plate, a first support, a second support, a cross beam, a fourth linear actuator, a first track, and a second track;
the first track being connected along the first frame-shaft;
the second track being connected along the second frame-shaft;
the first support being positioned parallel to the second support;
the push plate being perpendicularly connected to the first support and the second support;
the cross beam being connected to the first support and the second support, opposite of the push plate;
the push plate being positioned parallel to the front plate;
the first support being slidably engaged to the first track;
the second support being slidably engaged to the second track; and
the fourth linear actuator being terminally mounted to the cross beam and a tongue of the frame assembly.

7. The round hay bale pickup and releasing apparatus as claimed in claim 1 comprising:
the wheel assembly comprising a first wheel, a second wheel, an axle shaft, and an axle housing;
the axle shaft being rotatably mounted within the axle housing;
the first wheel and the second wheel being oppositely positioned of each other about the axle shaft;
the first wheel being mounted to the axle shaft; and
the second wheel being mounted to the axle shaft.

8. The round hay bale pickup and releasing apparatus as claimed in claim 1 comprising:
a tilting mechanism;
the tilting mechanism being positioned adjacent to wheel assembly; and
the wheel assembly being connected to the first frame-shaft and the second frame-shaft through the tilting mechanism, wherein the tilting mechanism angularly lifts up the first frame-shaft above the second frame-shaft.

9. The round hay bale pickup and releasing apparatus as claimed in claim 8 comprising:
the tilting mechanism comprising a first mount, a second mount, a connector shaft, and a fifth linear actuator;
the first mount being terminally connected to an axle housing of the wheel assembly;
the first mount being positioned in between the first frame-shaft and a first wheel of the wheel assembly;
the second mount being terminally connected to the axle housing;
the second mount being positioned in between the second frame-shaft and a second wheel of the wheel assembly;
the connector shaft being terminally connected to a free end of the first mount and the free end of the second mount;
the connector shaft being angularly oriented toward the rear plate;
the connector shaft being connected to the first frame-shaft and the second frame-shaft;
a first end of the connector shaft being positioned offset to the axle housing;
the first end of the connector shaft being positioned adjacent to the first frame-shaft;
a second end of the connector shaft being positioned adjacent to the axle housing;
the second end of the connector shaft being positioned adjacent to the second frame-shaft;
the fifth linear actuator being terminally mounted to the first frame-shaft and the axle housing; and
the fifth linear actuator being angularly oriented toward the front plate.

10. The round hay bale pickup and releasing apparatus as claimed in claim 9 comprising:
the connector shaft and the axle housing being positioned at a 45-degree angle; and
the fifth linear actuator and the axle housing being positioned at a 45-degree angle.

11. A round hay bale pickup and releasing apparatus comprising:
a frame assembly;
a loading-arm mechanism;
a bale-pushing mechanism:
a wheel assembly;
the frame assembly comprising a first frame-shaft, a second frame-shaft, a front plate, and a rear plate;
the loading-arm mechanism comprising a lift arm, a first bale gripper, a second bale gripper, a first linear actuator, a second linear actuator, and at least one third linear actuator;
the first frame-shaft and the second frame-shaft being positioned parallel to each other;
the first frame-shaft and the second frame-shaft being connected to each other by the front plate and the rear plate;
the front plate and the rear plate being oppositely positioned of each other about the first frame-shaft and the second frame-shaft;
the loading-arm mechanism being positioned adjacent to the front plate;
the loading arm being oriented away from the first frame-shaft;
the loading-arm mechanism being operatively coupled to the first frame-shaft and the second frame-shaft, wherein the loading-arm mechanism picks up and loads a round hay bale onto the first frame-shaft and the second frame-shaft;
the bale-pushing mechanism being positioned adjacent to the front plate;
the bale-pushing mechanism being operatively coupled to the first frame-shaft and the second frame-shaft, wherein the bale-pushing mechanism pushes the round hay bale from the front plate to the rear plate;
the wheel assembly being positioned in between the front plate and the rear plate;
the wheel assembly being mounted to the frame assembly;
a proximal end of the lift arm being rotatably connected to the first frame-shaft;
the at least one third linear actuator being terminally mounted to the second frame-shaft and the proximal end of the lift arm;
the first bale gripper being pivotably connected a distal end of the lift arm;
the first linear actuator being terminally mounted to the first bale gripper and the distal end of the lift arm;
the second bale gripper being pivotally connected the distal end of the lift arm; and
the second linear actuator being terminally mounted to the first bale gripper and the second bale gripper.

12. The round hay bale pickup and releasing apparatus as claimed in claim 11 comprising:
the frame assembly further comprising a swivel attachment, a tongue, and a fence;
the tongue being centrally positioned in between the first frame-shaft and the second frame-shaft;
the tongue being connected to the front plate;
the tongue being outwardly oriented from the front plate;
the swivel attachment being rotatably connected to the tongue;
the fence being externally connected to the second frame-shaft; and
the fence being oppositely positioned to the loading-arm mechanism.

13. The round hay bale pickup and releasing apparatus as claimed in claim 11 comprising:
the first bale gripper comprising an extension arm and a rolling arm;
the extension arm being terminally mounted to the distal end of the lift arm;
the rolling arm being positioned offset to the distal end of the lift arm;
the rolling arm being terminally connected to the extension arm at an acute angle;
the first linear actuator being terminally mounted to the extension arm and the distal end of the lift arm; and
the second linear actuator being terminally mounted to the extension arm and the second bale gripper.

14. The round hay bale pickup and releasing apparatus as claimed in claim 13 comprising:
the rolling arm comprising an elongated shaft and a bale roller;
the bale roller being rotatably mounted along the elongated shaft;
the elongated shaft being terminally connected to the extension arm; and
the bale roller being positioned in between the elongated shaft and the extension arm.

15. The round hay bale pickup and releasing apparatus as claimed in claim 11 comprising:
the bale-pushing mechanism comprising a push plate, a first support, a second support, a cross beam, a fourth linear actuator, a first track, and a second track;
the first track being connected along the first frame-shaft;
the second track being connected along the second frame-shaft;
the first support being positioned parallel to the second support;
the push plate being perpendicularly connected to the first support and the second support;
the cross beam being connected to the first support and the second support, opposite of the push plate;
the push plate being positioned parallel to the front plate;
the first support being slidably engaged to the first track;
the second support being slidably engaged to the second track; and
the fourth linear actuator being terminally mounted to the cross beam and a tongue of the frame assembly.

16. The round hay bale pickup and releasing apparatus as claimed in claim 11 comprising:
the wheel assembly comprising a first wheel, a second wheel, an axle shaft, and an axle housing;
the axle shaft being rotatably mounted within the axle housing;
the first wheel and the second wheel being oppositely positioned of each other about the axle shaft;
the first wheel being mounted to the axle shaft; and
the second wheel being mounted to the axle shaft.

17. The round hay bale pickup and releasing apparatus as claimed in claim 11 comprising:
a tilting mechanism;
the tilting mechanism being positioned adjacent to wheel assembly; and
the wheel assembly being connected to the first frame-shaft and the second frame-shaft through the tilting mechanism, wherein the tilting mechanism angularly lifts up the first frame-shaft above the second frame-shaft.

18. The round hay bale pickup and releasing apparatus as claimed in claim 17 comprising:
the tilting mechanism comprising a first mount, a second mount, a connector shaft, and a fifth linear actuator;
the first mount being terminally connected to an axle housing of the wheel assembly;
the first mount being positioned in between the first frame-shaft and a first wheel of the wheel assembly;
the second mount being terminally connected to the axle housing;
the second mount being positioned in between the second frame-shaft and a second wheel of the wheel assembly;
the connector shaft being terminally connected to a free end of the first mount and the free end of the second mount;
the connector shaft being angularly oriented toward the rear plate;
the connector shaft being connected to the first frame-shaft and the second frame-shaft;
a first end of the connector shaft being positioned offset to the axle housing;
the first end of the connector shaft being positioned adjacent to the first frame-shaft;
a second end of the connector shaft being positioned adjacent to the axle housing;
the second end of the connector shaft being positioned adjacent to the second frame-shaft;
the fifth linear actuator being terminally mounted to the first frame-shaft and the axle housing; and
the fifth linear actuator being angularly oriented toward the front plate.

19. The round hay bale pickup and releasing apparatus as claimed in claim 18 comprising:
the connector shaft and the axle housing being positioned at a 45-degree angle; and
the fifth linear actuator and the axle housing being positioned at a 45-degree angle.
